(19) United States
(12) Patent Application Publication
(10) Pub. No.: US 2007/0070857 A1
(43) Pub. Date: Mar. 29, 2007

(54) METHOD AND APPARATUS FOR ACCESSING AN OPTICAL STORAGE MEDIUM

(76) Inventors: Ping-Sheng Chen, Chia-Yi Hsien (TW); Shih-Hsin Chen, Tao-Yuan Hsien (TW); Yuan-Ting Wu, Hsin-Chu City (TW); Chih-Yuan Chen, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 11/535,980

(22) Filed: Sep. 27, 2006

(30) Foreign Application Priority Data
Sep. 28, 2005 (TW) 094133758

(51) Int. Cl. G11B 3/64

(52) U.S. Cl. 369/85

(57) ABSTRACT

A method for duplicating a second data recorded in a source storage medium to a target optical storage medium, wherein a first area of the target optical storage medium is recorded with a first data, the method includes: identifying the target optical storage medium as a blank optical storage medium and directly copying the second data recorded in the source storage medium to a second area of the target optical storage medium; and writing at least one of a start location, an end location, and a total length of the second data recorded on the target optical storage medium into the target optical storage medium.

### BACKGROUND

The present disclosure relates to optical storage techniques, and more particularly, to methods and apparatuses for accessing an optical storage medium.

Optical discs have become a popular storage media due in part to their ease of use, low cost, portability, and high capacity. For example, a conventional CD disc has a data capacity of 650 MB at the lower end up to 800 MB at the high end; a DVD-5 disc has a data capacity of 4.7 GB; a DVD-9 disc has a data capacity of 8.5 GB; and the newly introduced Blu-ray DVD has an even greater data capacity of over 20 GB.

The newly developed optical disc becomes more and more popular for several reasons, include: the new disc has a much larger capacity than the conventional optical disc, and the price of the newly-developed optical disc continuously falls. In general, the user can duplicate or copy data on a source optical disc to a target optical disc having a larger capacity by utilizing the functions such as: direct copy, fast copy, or disc copy. Said functionality is provided by various recording software. However, such a data duplication method involves a disc finalization process, which causes the remaining storage capacity of the target optical disc to become useless.

In the related art, when the user wants to duplicate or copy data, which have the same format but are respectively recorded on different source optical discs, onto a single target optical disc that has sufficient storage capacity, the user must utilize a recording software (or burning software) to rearrange or convert the data to be duplicated. The file systems, partial data, or whole data of those source optical discs must be converted into the same format before being recorded onto the target optical disc. For example, if the user wants to duplicate both a CD-Video format data and a DVD-Video format data onto a single target optical disc. Said two different format data must be converted into either DVD-Video format or CD-Video format so that they can be stored together on the same target optical disc. The above-mentioned rearrangement or format conversion of data not only wastes time but also requires appropriate format-conversion software.

Even when the user has suitable burning software or data duplication apparatus to achieve the foregoing functionality, unexpected deviation or data loss may occur during the data conversion process and thereby cause data errors existed in the target optical disc. In the worst case, the target optical disc may become unreadable.

In the related art, a data recording method named “mix mode” is able to record audio tracks and file data to a single optical disc. However, the mix mode recording method requires support from special burning software and the user must spend time to configure various recording parameters. Furthermore, since this recording method can only record data of the said two formats (i.e., audio track and file data) to a single optical disc, the practical application of mix mode is limited.

### SUMMARY OF THE INVENTION

An exemplary embodiment of a method for duplicating a second data recorded in a source storage medium to a target optical storage medium in which a first data is recorded in a first area of the target optical storage medium is disclosed. The method involves: identifying the target optical storage medium as a blank optical storage medium and directly copying the second data recorded in the source storage medium to a second area of the target optical storage medium; and writing at least one of a start location, an end location, and a total length of the second data recorded on the target optical storage medium into the target optical storage medium.

An exemplary embodiment of a machine readable medium is disclosed containing executable program code, which when executed by an optical storage device cause the optical storage device to perform the proposed data writing operations to duplicate a second data recorded in a source storage medium to a target optical storage medium.

An exemplary embodiment of a method for reading an optical storage medium recording a plurality of data and corresponding allocation information of each of the plurality of data is disclosed. The proposed method involves: determining if a specific information is stored in the optical storage medium, and transmitting a selection request to a host end if the specific information is stored in the optical storage medium; receiving a selection command, in response to the selection request, from the host end; looking up allocation information of a target data corresponding to the selection command; and retrieving the target data from the optical storage medium according to the allocation information of the target data; wherein the allocation information of the target data contain at least one of a start location, an end location, and a total length of the target data of the optical storage medium.

An exemplary embodiment of a machine readable medium is disclosed containing executable program code, which when executed by an optical storage device cause the optical storage device to perform the proposed data reading operations to read an optical storage medium.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a data replication system according to an exemplary embodiment.

FIG. 2 is a flowchart illustrating a method for duplicating data to the blank optical storage medium according to an exemplary embodiment.

FIG. 3 is a flowchart illustrating a method for duplicating data to a non-blank optical storage medium according to an exemplary embodiment.

FIG. 4 is a flowchart illustrating a method for reading an optical storage medium according to an exemplary embodiment.

### DETAILED DESCRIPTION

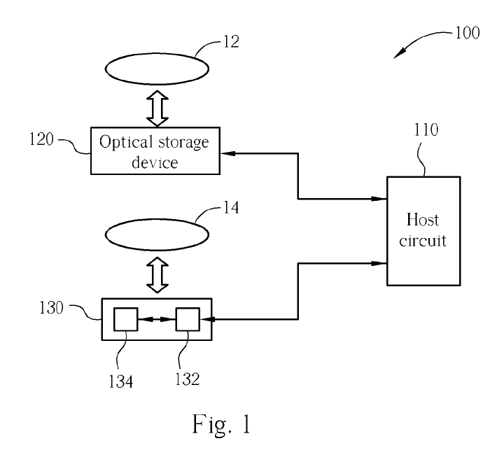

Please refer to FIG. 1, which shows a block diagram of a data replication system 100 according to an exemplary embodiment. As shown, the data replication system 100 comprises a host circuit 110; a first optical storage device 120 coupled to the host circuit 110 for reading data recorded on a source optical storage medium 12; and a second optical storage device 130 coupled to the host circuit 110 for writing data into a target optical storage medium 14. In this embodiment, the host circuit 110 is employed for communicating and coordinating data transmission between the first optical storage device 120 and the second optical storage device 130, but this is not a restriction of the practical functionalities of the host circuit 110.

Please note that the source optical storage medium 12 may be an optical disc of any type such as a CD-ROM disc, an audio CD, a VCD, a DVD, or any other recordable/re-writable optical disc. On the other hand, the target optical storage medium 14 may be a recordable/re-writable optical disc such as a CD-R disc, a CD-RW disc, a DVD-R disc, a DVD-RW disc, a DVD+R disc, a DVD+RW disc, a DVD-RAM disc, etc. In practice, the data replication system 100 may be a personal computer, an optical disc duplicator/copier, or the like.

As shown in FIG. 1, the second optical storage device 130 comprises a control circuit 132 and a machine readable medium 134. The machine readable medium 134 is usually a non-volatile memory arranged for storing executable program code FW, which is also referred to as firmware code. In this embodiment, the control circuit 132 controls the operations of the second optical storage device 130 according to the executable program code FW. Hereinafter, proposed methods for writing or duplicating data into the target optical storage medium 14 in different situations are explained.

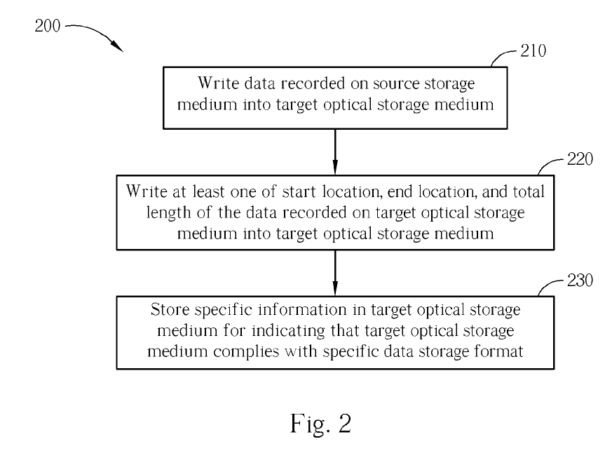

Firstly, the operations of writing data into the target optical storage medium 14 in a situation where the target optical storage medium 14 is a blank optical storage medium (e.g., a blank recordable/re-writable optical disc) are described. Please refer to FIG. 2, which shows a flowchart 200 illustrating a method for duplicating data recorded on a source storage medium to the blank target optical storage medium 14 according to an exemplary embodiment. In this embodiment, the source storage medium is the source optical storage medium 12, and the data to be duplicated is a data DA1 recorded on the source optical storage medium 12. The steps of the flowchart 200 are described in the following paragraphs.

In step 210, the second optical storage device 130 writes the data DA1 recorded on the source optical storage medium 12 into the target optical storage medium 14. Specifically, the data DA1 is firstly retrieved from the source optical storage medium 12 by the first optical storage device 120 and then transmitted to the second optical storage device 130 via the host circuit 110. Generally, the second optical storage device 130 temporarily stores the received data DA1 in a buffer (not shown), and then writes the data DA1 into the target optical storage medium 14 using a pick-up head.

If the data DA1 is the only data recorded on the source optical storage medium 12, the data DA1 can be completely duplicated from the source optical storage medium 12 to the target optical storage medium 14 by adopting the direct copy (a.k.a., fast copy, or disc copy) technique to minimize the time required. As a result, the data DA1 (including its lead-in area) recorded to the target optical storage medium 14 is identical as the data DA1 recorded in the source optical storage medium 12.

After step 210 is completed, the second optical storage device 130 performs step 220 to write at least one of a start location, an end location, and a total length of the data DA1 recorded on the target optical storage medium 14 into the target optical storage medium 14 as the allocation information of the data DA1. For example, the allocation information of the data DA1 can be recorded in the innermost area or the outermost area of the target optical storage medium 14. Alternatively, the allocation information of the data DA1 can also be recorded in the same area as the data DA1. In practice, the start location and the end location of the data DA1 recorded on the target optical storage medium 14 may be the start logic block address (LBA) and the end LBA of the data DA1 or the start physical block address (PBA) and the end PBA of the data DA1. Note that the operation of step 220 is not limited to being performed after step 210. For example, the operation of step 220 may be performed concurrently with step 210.

In step 230, the control circuit 132 of the second optical storage device 130 controls the second optical storage device 130 to store a specific information MX in the target optical storage medium 14 according to the program code FW stored in the machine readable medium 134. Please note that the specific information MX is not the conventional flag for indicating the format of data recorded on the target optical storage medium 14 of the related art. Instead, the specific information MX of this embodiment is employed for indicating that the target optical storage medium 14 complies with the data storage format proposed by the present disclosure. The role of the specific information MX will be described later. In practical implementations, the specific information MX recorded on the target optical storage medium 14 may be one or multiple identifiable predetermined patterns, marks, numbers, strings, etc. In addition, the content and length of the specific information MX are design choices and the specific information MX can be stored in any predetermined location within the target optical storage medium 14.

In practice, the source storage medium is not limited to only the optical storage media. For example, the source storage medium may be another data storage medium such as a hard disk drive, a web server, a portable storage medium (e.g., FLASH memory or pen drive), etc. Additionally, the execution order of the foregoing steps is not limited to the embodiment shown in FIG. 2. For example, step 230 can be performed before step 210, at the same time as step 210, or between step 210 and step 220.

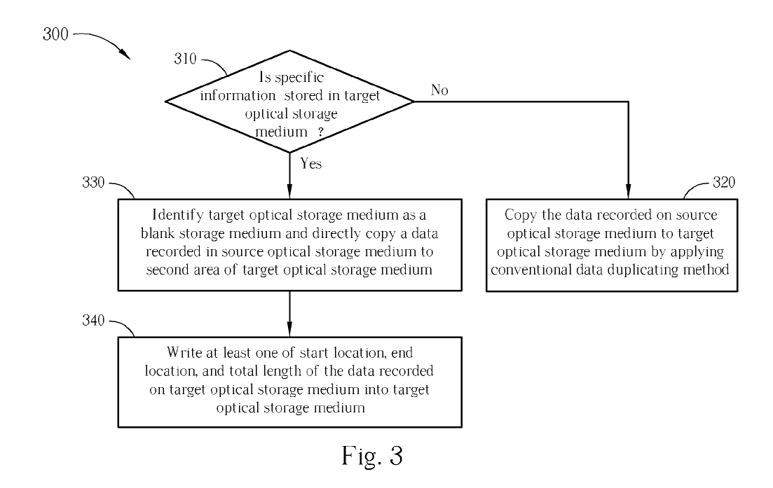

Hereinafter, the operations of writing data into the target optical storage medium 14 in another situation are described. In the situation, the target optical storage medium 14 has recorded some data but the remaining capacity is sufficient for recording other data. FIG. 3 shows a flowchart 300 illustrating a method for duplicating a data DA1 recorded on the source optical storage medium 12 to the target optical storage medium 14 according to an exemplary embodiment. Hereinafter assumes that a data DA0 has been recorded in a first area of the target optical storage medium 14 before duplicating the data DA1 to the target optical storage medium 14. The steps of the flowchart 300 are described in the following paragraphs.

In step 310, the control circuit 132 of the second optical storage device 130, according to the program code FW stored in the machine readable medium 134, determines if a specific information MX, as described earlier, is stored in the target optical storage medium 14. If no specific information MX has been stored in the target optical storage medium 14, then proceed to step 320. On the contrary, if the specific information MX is stored in the target optical storage medium 14, proceed to step 330.

In step 320, since no specific information MX has been stored in the target optical storage medium 14, the control circuit 132 of the second optical storage device 130 determines that the data DA0 is not written into the target optical storage medium 14 by applying the data writing method previously disclosed. Accordingly, the control circuit 132 of this embodiment controls the second optical storage device 130 to copy the data DA1 recorded on the source optical storage medium 12 to the target optical storage medium 14 by applying the conventional data duplicating method. As mentioned above, if the format of the data DA1 recorded on the source optical storage medium 12 differs from the data DA0 recorded on the target optical storage medium 14 (e.g., the data DA1 is CD-Video format and the data DA0 is DVD-Video format), the data DA1 must be converted into the same format as the data DA0 before writing the data DA1 to the target optical storage medium 14.

On the contrary, in step 330, the control circuit 132 of the second optical storage device 130 determines that the data DA0 was written into the target optical storage medium 14 having applied the data writing method proposed by the present invention due to the specific information MX being recorded in the target optical storage medium 14. In other words, the target optical storage medium 14 complies the specific data storage format proposed by the present disclosure. In this situation, the control circuit 132 of the second optical storage device 130 identifies the target optical storage medium 14 as a blank optical storage medium when duplicating the data DA1 to the target optical storage medium 14. Please note that the control circuit 132 of this embodiment can identify that the target optical storage medium 14 is not blank since the existence of data DA0 is detected, but the control circuit 132 purposely reports to the host circuit 110 that the target optical storage medium 14 is blank, so that the host circuit 110 misinterprets the target optical storage medium 14 as being blank. As a result, the host circuit 110 allows the first optical storage device 120 and the second optical storage device 130 to perform direct copying operations.

By this way, the data DA1 recorded on the source optical storage medium 12 is quickly and completely duplicated to the target optical storage medium 14 by adopting the direct copying method in step 330 without any data rearrangement or format conversion processes. In other words, even in the situation where the format of the data DA1 differs from the format of the existing data DA0 of the target optical storage medium 14, the second optical storage device 130 still writes the data DA1 into the target optical storage medium 14 while retaining the original format of the data DA1. When duplicating the data DA1, the control circuit 132 controls the second optical storage device 130 to write the data DA1 into a second area, which does not overlap the first area of the target optical storage medium 14 to avoid overwriting the existing data DA0 recorded in the first area by the data DA1.

Next, in step 340, the control circuit 132 controls the second optical storage device 130 to write at least one of a start location, an end location, and a total length of the data DA1 recorded on the target optical storage medium 14 into the target optical storage medium 14 as the allocation information of the data DA1 according to the executable program code FW. In practice, the allocation information of the data DA1 can be recorded in the first area, the second area, or a third area other than the first and second areas of the target optical storage medium 14 such as the innermost area or outermost area of the target optical storage medium 14. In practical implementations, step 340 can be performed concurrently with step 330 or after step 330. The operation of step 340 is substantially the same as step 220, and therefore further details are omitted herein for the sake of brevity.

In other words, if the target optical disc has sufficient capacity, a data duplication system applying the proposed data duplicating method described above is able to sequentially duplicate data recorded on different source optical discs to different areas of the target optical disc by employing the direct copy means. As a result, when the user wishes to create a backup copy of data recorded on several source optical discs of different formats, those source optical discs can be completely duplicated, disc-by-disc, to a target optical disc having sufficient capacity by using commonly available (i.e., non-specialized) recording software. This method not only significantly improves the efficiency and reliability (e.g., correctness, error-free) of disc duplication but this method also provides for storing data from different optical discs in a single optical disc while retaining their own specific data format and file system. Therefore, the backup operation of optical discs can be achieved easier and quicker. For example, the user can store data of an optical disc whose file system complies with the universal disk format (UDF) and data of another optical disc whose file system complies with the ISO 9660 format in a single optical disc. By this way, data on audio discs, VCD discs, CD-ROM discs, DVD discs, and various other types of recordable/re-writable optical discs can be quickly and completely duplicated to a single optical disc having sufficient capacity.

Note that the data source in the disclosed data duplicating method is not limited to optical storage media. When the target optical storage medium 14 has recorded some data, the disclosed data duplicating method can also be applied to duplicate data recorded on other data storage media (e.g., hard disk drives, web servers, FLASH memory, pen drives, etc.) to the target optical storage medium 14. In such a case, the data duplicating operation of step 330 cannot be achieved by the direct copy means because the data source is not an optical disc.

The disclosed method for accessing an optical storage medium can be realized by modifying the firmware code of an optical storage device without changing the circuitry design of the optical storage device. Therefore, the hardware cost is not increased.

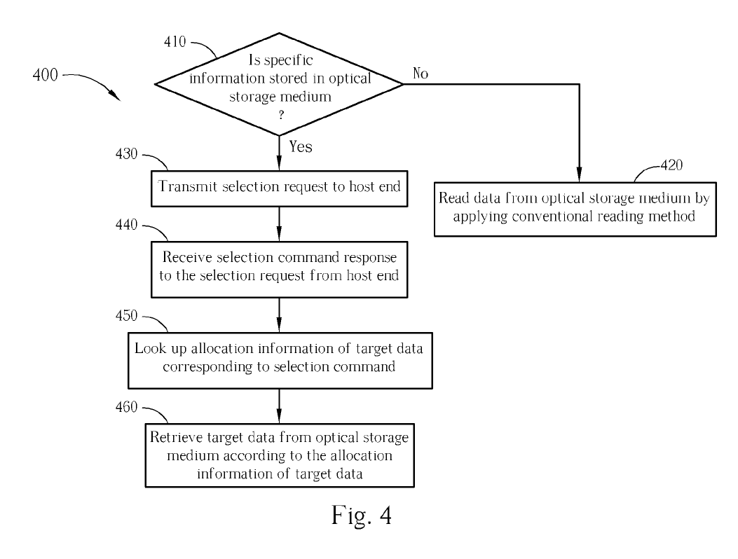

Hereinafter, the operations of reading an optical storage medium to which data has written by the disclosed data recording processes are described. Please refer to FIG. 4, which shows a flowchart 400 illustrating a method for reading an optical storage medium OSM according to an exemplary embodiment. The steps of the flowchart 400 are described in the following paragraphs.

In step 410, an optical storage device, such as the aforementioned second optical storage device 130, is employed to determine if a specific information MX as previously described is stored in the optical storage medium OSM. If no specific information MX is stored in the optical storage medium OSM, proceed to step 420. On the contrary, if the specific information MX is stored in the optical storage medium OSM, proceed to step 430.

In step 420, since there is no specific information MX stored in the optical storage medium OSM, it is known that the data recorded in the optical storage medium OSM is not written by applying the proposed data duplicating method previously described. Accordingly, the optical storage device reads the optical storage medium OSM by adopting conventional reading means and further details are omitted herein for the sake of brevity.

In step 430, since the specific information MX is recorded in the optical storage medium OSM, the optical storage device accordingly identifies that data recorded on the optical storage medium OSM as having been written by applying the proposed data writing method. Therefore, the optical storage device transmits a selection request to a host end (also referred to as a reproducing terminal) for asking the host end to instruct which one of a plurality of data stored in the optical storage medium OSM has to be retrieved. The host end usually displays the titles or other recognizable identification information of the plurality of data to the user in the form of menus or dialog boxes so that the user can choose a target data through the menus or dialog boxes. In practice, the host end may be a computer or a DVD player but this is not a restriction of the practical applications.

After the user has selected a target data from the plurality of data, the host end issues a corresponding selection command in response to the selection request, and the optical storage device receives the selection command from the host end in step 440.

Next, in step 450, the optical storage device looks up allocation information of the target data corresponding to the selection command in the optical storage medium OSM, and then performs step 460 to retrieve the target data from the optical storage medium OSM according to the allocation information. Since the optical storage medium complies with the data storage format proposed by this disclosure, the allocation information of the target data contains at least one of the start location, the end location, and the total length of the target data recorded on the optical storage medium OSM. The optical storage device can perform a mapping conversion of a logical address according to allocation information to obtain the address of the target data and then the optical storage device can retrieve the target data from the optical storage medium OSM.

For example, assume that the optical storage medium OSM has recorded three data, which are data DA0 recorded from LBA 0 through LBA 30000 of the optical storage medium OSM, data DA1 recorded from LBA 30000+N through LBA 50000+N, and data DA2 recorded from LBA 50000+2N through LBA 85000+2N, where N is the interval between adjacent data. Suppose that the data DA2 is the target data corresponding to the selection command and is written into the optical storage medium OSM by employing the direct copying means. As previously described, the data DA2 retains the same file system format as its source optical disc. The optical storage device can obtain the start logical address of the data DA2 is LBA 50000+2N and the end logical address of the data DA2 is LBA 85000+2N by converting the allocation information of the target data DA2, whereby the target data DA2 can be successful retrieved. In this embodiment, the optical storage device returns required information for reading the target data DA2 to the host end. For example, if the target data DA2 is originally recorded in a CD disc, the optical storage device returns to the host end a table of content (TOC), which is identical to the TOC recorded on the original CD disc. If the target data DA2 is originally recorded in a DVD disc, the optical storage device returns to the host end a DVD structure command, which is identical to the DVD structure command recorded on the original DVD disc.

In other words, the disclosed method simulates command responses and returns to the host end said command responses, which are identical to command responses given the situation where the optical storage medium only recorded the target data thereon. As a result, the target data can be provided for use in the original format or style.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for duplicating a second data recorded in a source storage medium to a target optical storage medium, a first data recorded in a first area of the target optical storage medium, the method comprising:
(a) identifying the target optical storage medium as a blank optical storage medium and directly copying the second data recorded in the source storage medium to a second area of the target optical storage medium; and
(b) writing at least one of a start location, an end location, and a total length of the second data recorded on the target optical storage medium into the target optical storage medium.

2. The method of claim 1, further comprising:
(c) determining if a specific information is stored in the target optical storage medium, and step (a) is performed if the specific information is stored in the target optical storage medium;
wherein the specific information indicates that the target optical storage medium complies with a specific data storage format.

3. The method of claim 1, wherein the target optical storage medium is an optical disc.

4. The method of claim 1, wherein the source storage medium is an optical disc.

5. The method of claim 1, wherein a lead-in area of the second data stored in the target optical storage medium is identical to the lead-in area of the second data stored in the source storage medium.

6. The method of claim 1, wherein the first data and the second data correspond to different file systems.

7. A method for reading an optical storage medium recording a plurality of data and corresponding allocation information of each of the plurality of data, the method comprising:
determining if a specific information is stored in the optical storage medium, and transmitting a selection request to a host end if the specific information is stored in the optical storage medium;
receiving a selection command in response to the selection request from the host end;
looking up allocation information of a target data corresponding to the selection command; and
retrieving the target data from the optical storage medium according to the allocation information of the target data;
wherein the allocation information of the target data contains at least one of a start location, an end location, and a total length of the target data recorded on the optical storage medium.

8. The method of claim 7, wherein the specific information indicates that the optical storage medium complies with a specific data storage format.

9. The method of claim 7, wherein the optical storage medium is an optical disc.

10. A machine readable medium containing executable program code, which when executed by an optical storage device cause the optical storage device to perform data writing operations to duplicate a second data recorded in a source storage medium to a target optical storage medium, wherein a first data is recorded in a first area of the target optical storage medium, the data writing operations comprising:
(a) identifying the target optical storage medium as a blank optical storage medium and directly copying the second data recorded in the source storage medium to a second area of the target optical storage medium; and
(b) writing at least one of a start location, an end location, and a total length of the second data recorded on the target optical storage medium into the target optical storage medium.

11. The machine readable medium of claim 10, wherein the data writing operations further comprise:
(c) determining if a specific information is stored in the target optical storage medium, and step (a) is performed if the specific information is stored in the target optical storage medium;
wherein the specific information indicates that the target optical storage medium complies with a specific data storage format.

12. The machine readable medium of claim 10, wherein the target optical storage medium is an optical disc.

13. The machine readable medium of claim 10, wherein the source storage medium is an optical disc.

14. The machine readable medium of claim 10, wherein a lead-in area of the second data stored in the target optical storage medium is identical to the lead-in area of the second data stored in the source storage medium.

15. The machine readable medium of claim 10, wherein the first data and the second data correspond to different file systems.

16. A machine readable medium containing executable program code, which when executed by an optical storage device cause the optical storage device to perform data reading operations to read an optical storage medium recording a plurality of data and corresponding allocation information of each of the plurality of data, the data reading operations comprising:
determining if a specific information is stored in the optical storage medium, and transmitting a selection request to a host end if the specific information is stored in the optical storage medium;
receiving a selection command in response to the selection request from the host end;
looking up allocation information of a target data corresponding to the selection command; and
retrieving the target data from the optical storage medium according to the allocation information of the target data;
wherein the allocation information of the target data contain at least one of a start location, an end location, and a total length of the target data of the optical storage medium.

17. The machine readable medium of claim 16, wherein the optical storage medium is an optical disc.

18. A method for writing data into a blank target optical storage medium comprising:
duplicating a first data recorded in a source storage medium to the target optical storage medium;
writing at least one of a start location, an end location, and a total length of the first data recorded on the target optical storage medium into the target optical storage medium; and
storing a specific information in the target optical storage medium to indicate that the target optical storage medium complies with a specific data storage format.
